(19) United States
(12) Patent Application Publication
(10) Pub. No.: US 2018/0145330 A1
(43) Pub. Date: May 24, 2018

(54) OLIGOMER AND LITHIUM BATTERY

(71) Applicant: National Taiwan University of Science and Technology, Taipei (TW)

(72) Inventors: Fu-Ming Wang, Taipei (TW); Chorng-Shyan Chern, Taipei (TW); Jung-Mu Hsu, Taipei (TW)

(73) Assignee: National Taiwan University of Science and Technology, Taipei (TW)

(21) Appl. No.: 15/591,897

(22) Filed: May 10, 2017

(30) Foreign Application Priority Data
Nov. 18, 2016 (TW) 105137884

(51) Int. Cl. H01M 4/60; H01M 10/0525; H01M 10/0567; C08G 73/06

(52) U.S. Cl. CPC H01M 4/60; H01M 10/0525; H01M 2004/028; C08G 73/0633; H01M 10/0567

(57) ABSTRACT

An oligomer and a lithium battery are provided. The oligomer is obtained by reacting a maleimide, a barbituric acid, and a promoter in a solvent. The promoter has the structure represented by formula 1:

X—(R)₃ formula 1,
wherein X is N or P; R is a substituted or unsubstituted alkyl group or a substituted or unsubstituted aryl group. The lithium battery includes an anode, a cathode, a separator, an electrolyte solution, and a package structure, wherein the cathode includes the oligomer.

### CROSS-REFERENCE TO RELATED APPLICATION

This application claims the priority benefit of Taiwan application serial no. 105137884, filed on Nov. 18, 2016. The entirety of the above-mentioned patent application is hereby incorporated by reference herein and made a part of this specification.

### BACKGROUND OF THE INVENTION

### Field of the Invention

The invention relates to an oligomer and a battery, and more particularly, to an oligomer for a lithium battery and a lithium battery.

### Description of Related Art

Since primary batteries are not environment-friendly, the market demand for secondary lithium batteries with characteristics such as rechargeability, light weight, high voltage value, and high energy density has been growing in recent years. As a result, current performance requirements for the secondary lithium battery such as lightweight, durability, high voltage, high energy density, and high safety have also become higher. In particular, secondary lithium batteries have relatively high potential in the application and expandability in light electric vehicles, electric vehicles, and the large power storage industry.

However, among the commercialized secondary lithium batteries in the general market, since lithium transition metal oxide is used as the cathode, the cathode readily reacts with the electrolyte solution in high temperature applications and becomes damaged. As a result, oxygen in the lithium metal oxide is released and becomes part of a combustion reaction. This is one of the main causes for the explosion, swelling, and performance degradation of the secondary lithium battery. Therefore, continuously maintaining the structural stability and high performance of the cathode material in high temperature applications is one of the desired goals of those skilled in the art.

### SUMMARY OF THE INVENTION

The invention provides an oligomer that can be applied in the cathode material of a lithium battery such that the lithium battery has good performance.

The invention provides a lithium battery having the oligomer.

The oligomer of the invention is obtained by reacting a maleimide (MI), a barbituric acid (BTA), and a promoter in a solvent. The promoter has the structure represented by formula 1:

X—(R)₃ formula 1,

wherein X is N or P; R is a substituted or unsubstituted C1-C10 alkyl group or a substituted or unsubstituted C6-C10 aryl group.

In an embodiment of the oligomer of the invention, X is, for instance, P, and R is, for instance, a phenyl group.

In an embodiment of the oligomer of the invention, X is, for instance, N, and R is, for instance, an ethyl group.

In an embodiment of the oligomer of the invention, the molar ratio of the maleimide and the barbituric acid is, for instance, between 1:1 and 4:1.

In an embodiment of the oligomer of the invention, based on the total weight of the maleimide, the barbituric acid, and the promoter, the amount of the promoter is, for instance, between 5 wt % and 20 wt %.

In an embodiment of the oligomer of the invention, based on the total weight of the maleimide, the barbituric acid, and the solvent, the total amount of the maleimide and the barbituric acid is, for instance, between 5 wt % and 20 wt %.

In an embodiment of the oligomer of the invention, the maleimide is, for instance, monomaleimide or bismaleimide, the monomaleimide is, for instance, N-phenylmaleimide, N-(o-methylphenyl)-maleimide, N-(m-methylphenyl)-maleimide, N-(p-methylphenyl)-maleimide, N-cyclohexylmaleimide, maleimidophenol, maleimidobenzocyclobutene, phosphorus-containing maleimide, phosphonate-containing maleimide, siloxane-containing maleimide, N-(4-tetrahydropyranyl-oxyphenyl)maleimide, or 2,6-xylylmaleimide, and the bismaleimide, for instance, has the structure represented by formula 2:

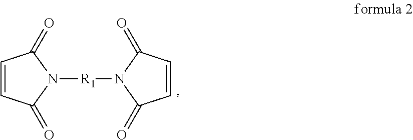

wherein R₁ is —(CH₂)₂—, —(CH₂)₆—, —(CH₂)₈—, —(CH₂)₁₂—,

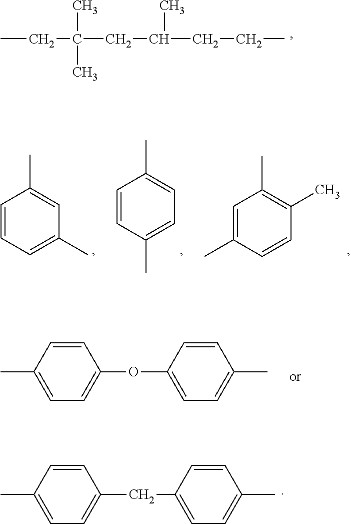

In an embodiment of the oligomer of the invention, the barbituric acid has the structure represented by formula 3:

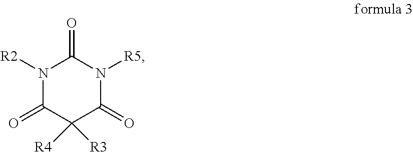

wherein R2, R3, R4, and R5 are each independently —H, —CH₃, —C₂H₅, —C₆H₅, —CH(CH₃)₂, —CH₂CH(CH₃)₂, —CH₂CH₂CH(CH₃)₂, or —CH(CH₃)—(CH₂)₂—CH₃.

A lithium battery of the invention includes an anode, a cathode, a separator, an electrolyte solution, and a package structure. The cathode and the anode are separately disposed, and the cathode includes the oligomer. The separator is disposed between the anode and the cathode, and the separator, the anode, and the cathode define a housing region. The electrolyte solution is disposed in the housing region. The package structure covers the anode, the cathode, and the electrolyte solution.

In an embodiment of the lithium battery of the invention, the electrolyte solution includes an organic solvent, a lithium salt, and an additive, wherein the additive is, for instance, monomaleimide, polymaleimide, bismaleimide, polybismaleimide, a copolymer of bismaleimide and monomaleimide, vinylene carbonate, or a mixture thereof.

Based on the above, the oligomer of the invention is prepared by reacting a maleimide, a barbituric acid, and a promoter in a solvent, and therefore the time of the addition reaction of the maleimide and the barbituric acid can be effectively reduced, and the conversion rate of the addition reaction can be increased, such that lithium battery performance is increased.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional schematic diagram of a lithium battery according to an embodiment of the invention.

FIG. 2A is the result of reaction heat release analysis of experimental example 1.

FIG. 2B is the result of reaction heat release analysis of comparative example 1.

FIG. 3 is the charge and discharge analysis result of lithium batteries having the oligomers of experimental example 1 and comparative example 1.

FIG. 4 is the result of reaction heat release analysis of experimental example 2.

### DESCRIPTION OF THE EMBODIMENTS

To prepare a cathode material suitable for a lithium battery to provide the lithium battery with an oligomer having good performance, in the invention, an oligomer is prepared by reacting a maleimide, a barbituric acid, and a promoter in a solvent. In the following, embodiments are provided to describe actual implementations of the invention.

In an embodiment of the invention, an oligomer is prepared by reacting a maleimide, a barbituric acid, and a promoter in a solvent, wherein the promoter is used to accelerate the addition polymerization of the maleimide and the barbituric acid to form the oligomer, and therefore reaction time can be effectively reduced.

<Maleimide>

In the invention, the maleimide can be monomaleimide or bismaleimide. Examples of the monomaleimide include N-phenylmaleimide, N-(o-methylphenyl)-maleimide, N-(m-methylphenyl)-maleimide, N-(p-methylphenyl)-maleimide, N-cyclohexylmaleimide, maleimidophenol, maleimidobenzocyclobutene, phosphorus-containing maleimide, phosphonate-containing maleimide, siloxane-containing maleimide, N-(4-tetrahydropyranyl-oxyphenyl)maleimide, or 2,6-xylylmaleimide. Examples of the bismaleimide include the structure represented by formula 2:

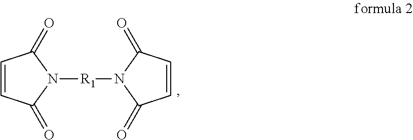

wherein R₁ is —(CH₂)₂—, —(CH₂)₆—, —(CH₂)₈—, —(CH₂)₁₂—,

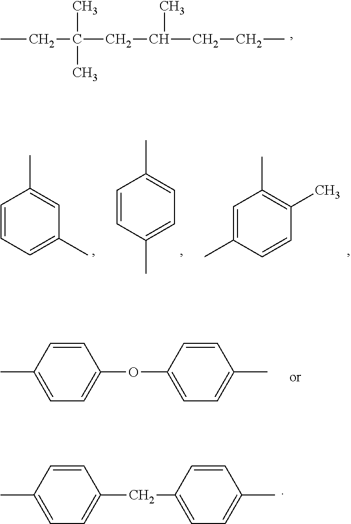

<Barbituric Acid>

In the invention, the barbituric acid has the structure represented by formula 3:

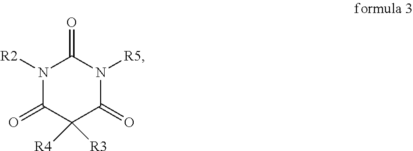

wherein R2, R3, R4, and R5 are each independently —H, —CH₃, —C₂H₅, —C₆H₅, —CH(CH₃)₂, —CH₂CH(CH₃)₂, —CH₂CH₂CH(CH₃)₂, or —CH(CH₃)—(CH₂)₂—CH₃.

<Promoter>

In the invention, the promoter has the structure represented by formula 1:

X—(R)₃ formula 1,

wherein X is N or P; R is a substituted or unsubstituted C1-C10 alkyl group or a substituted or unsubstituted C6-C10 aryl group. In an embodiment, the promoter can be P—(Ph)₃, wherein Ph represents a phenyl group. In another embodiment, the promoter can be N—(CH₂CH₃)₃. The promoter can accelerate the addition polymerization of the maleimide and the barbituric acid in the solvent to reduce reaction time.

<Solvent>

In the invention, the solvent can be an organic solvent, and examples thereof include N-methyl pyrollidone (NMP), γ-butylrolactone (GBL), or propylene carbonate (PC). The solvent can be used alone or in combination.

In an embodiment of the invention, the oligomer is obtained by reacting a maleimide, a barbituric acid, and a promoter in a solvent. More specifically, addition polymerization can be performed by reacting a maleimide and a barbituric acid in a solvent using a Michael addition reaction, and the conversion rate of the Michael addition reaction can be increased by a promoter. The molar ratio of the maleimide and the barbituric acid is, for instance, between 1:1 and 4:1. If the molar ratio of the maleimide and the barbituric acid is less than 1:1, then reactivity is poor. If the molar ratio of the maleimide and the barbituric acid is higher than 4:1, then an electrochemical side reaction readily occurs. The temperature of the addition polymerization reaction is, for instance, between room temperature and 150° C., and the reaction time is, for instance, between 0.5 hours and 5 hours.

Moreover, based on the total weight of the maleimide, the barbituric acid, and the promoter, the amount of the promoter is, for instance, between 5 wt % and 20 wt %. If the amount of the promoter is less than 5 wt %, then the conversion rate of the addition reaction cannot be effectively increased. If the amount of the promoter is higher than 20 wt %, then costs are increased, and the conversion rate of the addition reaction is not readily increased.

Moreover, based on the total weight of the maleimide, the barbituric acid, and the solvent, the total amount of the maleimide and the barbituric acid is, for instance, between 5 wt % and 20 wt %. If the total amount of the maleimide and the barbituric acid is less than 5 wt %, then the molecular weight of the oligomer is too small and the heat release of the electrode of the lithium battery cannot be effectively reduced. If the total amount of the maleimide and the barbituric acid is higher than 20 wt %, then the molecular weight of the resulting oligomer is too large such that the difficulty of electrode preparation is increased and the oligomer is not suitable for a lithium battery.

The oligomer of the invention can be applied in the cathode material of a lithium battery. More specifically, the oligomer of the invention has good thermal reactivity, and therefore forms a protective layer on the surface of the cathode material to effectively block damage to the cathode structure in a high-temperature environment. The reasons are as follows: the resulting oligomer has a highly-branched structure and can therefore form a stable organic polymer with the metal oxide in a regular cathode material, and the oligomer has high thermal reactivity, high stability, and a rigid chemical structure, and therefore can provide high thermal stability to the resulting protective layer. As a result, the lithium battery having a cathode material including the oligomer of the invention can have good capacitance, battery efficiency, and safety in a high-temperature environment, and have excellent battery cycle life.

In the following, the lithium battery including the oligomer of the invention is described.

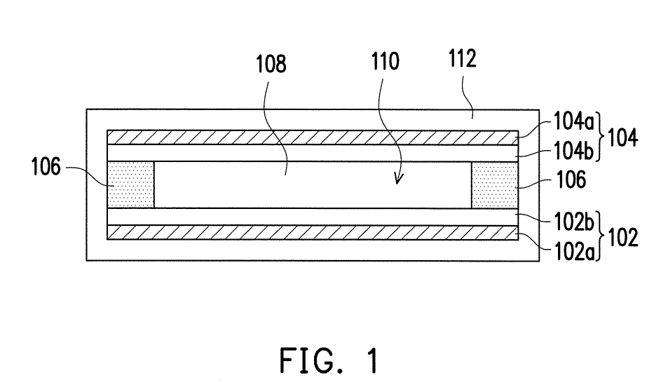

FIG. 1 is a cross-sectional schematic diagram of a lithium battery according to an embodiment of the invention. Referring to FIG. 1, a lithium battery 100 includes an anode 102, a cathode 104, a separator 106, an electrolyte solution 108, and a package structure 112.

The anode 102 includes an anode metal foil 102a and an anode material 102b, wherein the anode material 102b is disposed on the anode metal foil 102a through coating or sputtering. The anode metal foil 102a is, for instance, a copper foil, an aluminum foil, a nickel foil, or a high-conductivity stainless steel foil. The anode material 102b is, for instance, carbide or metal lithium. The carbide is, for instance, carbon powder, graphite, carbon fiber, carbon nanotube, graphene, or a mixture thereof. However, in other embodiments, the anode 102 can also only include the anode material 102b.

The cathode 104 and the anode 102 are separately disposed. The cathode 104 includes a cathode metal foil 104a and a cathode material 104b, wherein the cathode material 104b is disposed on the cathode metal foil 104a through coating. The cathode metal foil 104a is, for instance, a copper foil, an aluminum foil, a nickel foil, or a high-conductivity stainless steel foil. The cathode material 104b includes the oligomer of the invention and a lithium-mixed transition metal oxide. The lithium-mixed transition metal oxide is, for instance, LiMnO₂, LiMn₂O₄, LiCoO₂, Li₂Cr₂O₇, Li₂CrO₄, LiNiO₂, LiFeO₂, LiNiₓCo₁₋ₓO₂, LiFePO₄, LiMn_{0.5}Ni_{0.5}O₂, LiMn_{1/3}Co_{1/3}Ni_{1/3}O₂, LiMc_{0.5}Mn_{1.5}O₄, or a combination thereof, wherein 0<x<1 and Mc is a divalent metal.

Based on a total weight of 100 parts by weight of the cathode material 104b, the content of the oligomer is 0.5 parts by weight to 5 parts by weight (preferably 1 part by weight to 3 parts by weight). The content of the lithium-mixed transition metal oxide is, for instance, 80 parts by weight to 95 parts by weight. If the content of the oligomer is less than 0.5 parts by weight, then the battery safety characteristic is not significant; and if the content of the oligomer is higher than 5 parts by weight, then battery cycle life is poor.

Moreover, the lithium battery 100 can further include a polymer binder. The polymer binder reacts with the anode 102 and/or the cathode 104 to increase the mechanical properties of the electrode(s). Specifically, the anode material 102b can be adhered to the anode metal foil 102a through the polymer binder, and the cathode material 104b can be adhered to the cathode metal foil 104a through the polymer binder. The polymer binder is, for instance, polyvinylidene difluoride (PVDF), styrene-butadiene rubber (SBR), polyamide, melamine resin, or a combination thereof.

The separator 106 is disposed between the anode 102 and the cathode 104, and the separator 106, the anode 102, and the cathode 104 define a housing region 110. The material of the separator 106 is an insulating material such as polyethylene (PE), polypropylene (PP), or a composite structure (such as PE/PP/PE) formed by the above materials.

The electrolyte solution 108 is disposed in the housing region 110. The electrolyte solution 108 includes an organic solvent, a lithium salt, and an additive. The amount of the organic solvent in the electrolyte solution 108 is 55 wt % to 90 wt %, the amount of the lithium salt in the electrolyte solution 108 is 10 wt % to 35 wt %, and the amount of the additive in the electrolyte solution 108 is 0.05 wt % to 10 wt %. However, in other embodiments, the electrolyte solution 108 may also not contain an additive.

The organic solvent is, for instance, γ-butyl lactone, ethylene carbonate (EC), propylene carbonate, diethyl carbonate (DEC), propyl acetate (PA), dimethyl carbonate (DMC), ethylmethyl carbonate (EMC), or a combination thereof.

The lithium salt is, for instance, LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or a combination thereof.

The additive is, for instance, monomaleimide, polymaleimide, bismaleimide, polybismaleimide, a copolymer of bismaleimide and monomaleimide, vinylene carbonate (VC), or a mixture thereof. The monomaleimide is, for instance, selected from the group consisting of N-phenylmaleimide, N-(o-methylphenyl)-maleimide, N-(m-methylphenyl)-maleimide, N-(p-methylphenyl)-maleimide, N-cyclohexylmaleimide, maleimidophenol, maleimidobenzocyclobutene, phosphorus-containing maleimide, phosphonate-containing maleimide, siloxane-containing maleimide, N-(4-tetrahydropyranyl-oxyphenyl)maleimide, and 2,6-xylylmaleimide.

The package structure 112 covers the anode 102, the cathode 104, and the electrolyte solution 108. The material of the package structure 112 is, for instance, aluminum foil.

It should be mentioned that, the cathode 104 can be formed by adding the oligomer of the invention in the cathode material in a current battery manufacturing process. Therefore, the capacitance, battery efficiency, and charge and discharge cycle life of the lithium battery 100 can be effectively maintained at high temperature without modifying any battery design, electrode material, and electrolyte solution, and the lithium battery 100 can have higher safety.

In the following, the effects of the oligomer of the invention are described with experimental examples and comparative examples.

### Experimental Example 1

A maleimide and a barbituric acid at a molar ratio of 1:1 and 10 parts by weight (based on the total weight of the maleimide and the barbituric acid) of a promoter (P—(Ph)₃) were placed in a reaction vessel with an NMP solvent, and the components were reacted at a temperature of 130° C. to form an oligomer.

### Experimental Example 2

A maleimide and a barbituric acid at a molar ratio of 1:1 and 10 parts by weight (based on the total weight of the maleimide and the barbituric acid) of a promoter (N—(CH₂CH₃)₃) were placed in a reaction vessel with an NMP solvent, and the components were reacted at a temperature of 130° C. to form an oligomer.

### Comparative Example 1

A maleimide and a barbituric acid at a molar ratio of 1:1 were placed in a reaction vessel with an NMP solvent, and the components were reacted at a temperature of 130° C. to form an oligomer.

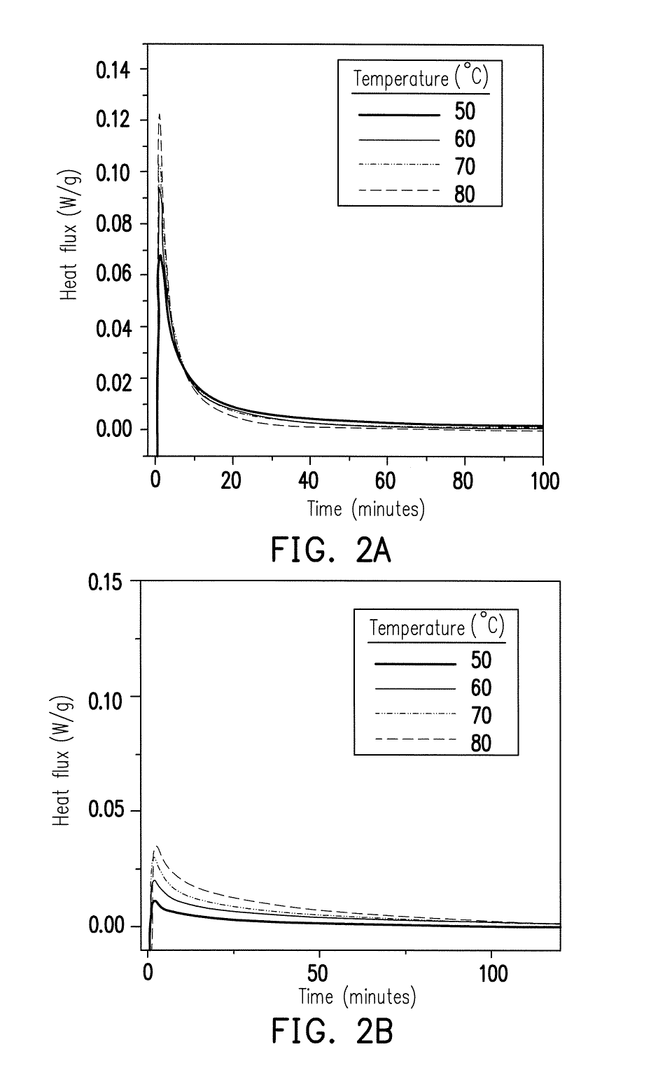

FIG. 2A is the result of reaction heat release analysis of experimental example 1. FIG. 2B is the result of reaction heat release analysis of comparative example 1. Referring to FIG. 2A and FIG. 2B, after respectively reacting at constant temperatures of 50° C., 60° C., 70° C., and 80° C. for 2 hours using a thermal analyzer, the heat released in experimental example 1 was respectively 34.12 J/g, 34.37 J/g, 34.52 J/g, and 34.53 J/g, and the heat released in comparative example 1 was respectively 14.82 J/g, 20.51 J/g, 29.47 J/g, and 46.15 J/g. It can be seen from FIG. 2A and FIG. 2B that, in comparative example 1, the reaction heat release is increased with reaction temperature, and in experimental example 1, the reaction heat release is also increased with increase in reaction temperature and the reaction time is shorter (3 minutes to 5 minutes). Therefore, in the invention, preparing the oligomer by reacting a maleimide, a barbituric acid, and a promoter in a solvent can effectively increase the conversion rate of the addition reaction of the maleimide and the barbituric acid, and the reaction can be completed at a lower temperature.

Moreover, a thermochemical kinetics analysis was performed on the oligomer of experimental example 1 and the oligomer of comparative example 1. The results show that, the activation energy of the oligomer of comparative example 1 is 45 kJ/mol, and the activation energy of the oligomer of experimental example 1 reaches 32 kJ/mol. Therefore, preparing the oligomer by reacting a maleimide, a barbituric acid, and a promoter in a solvent can significantly reduce the barrier to the reaction to achieve the object of high conversion rate.

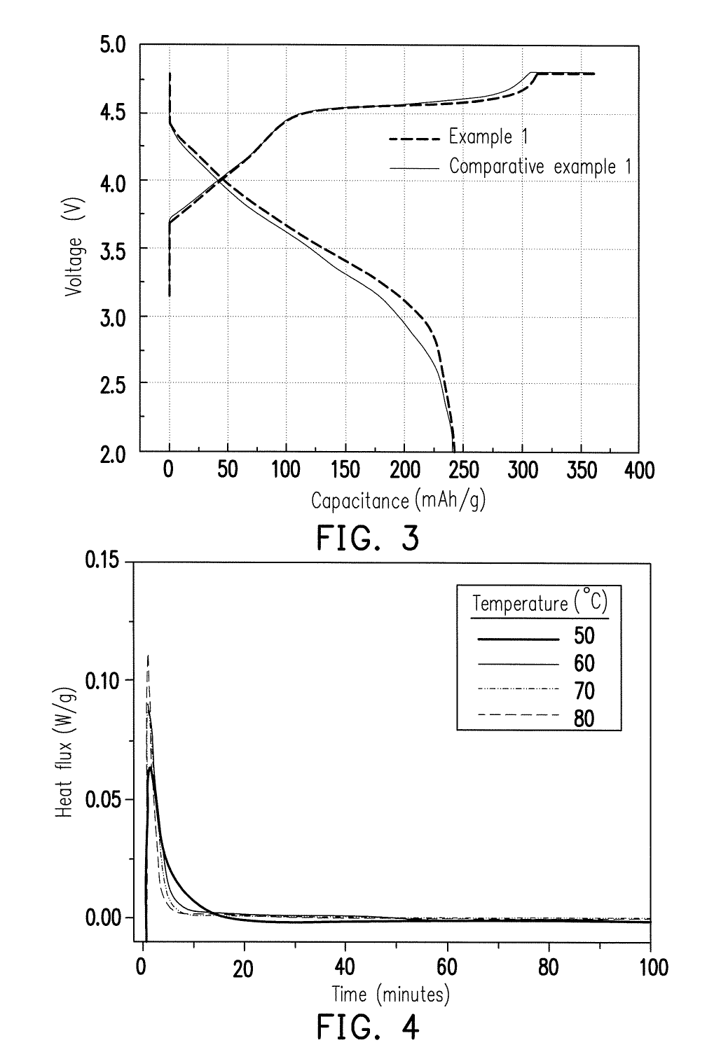

The oligomers of experimental example 1 and comparative example 1 were respectively applied in the cathode material of the same lithium battery, and a charge and discharge analysis was performed on the lithium battery. It can be seen from FIG. 3 that, the oligomer of experimental example 1 can increase power density by about 12%, and therefore the performance of the lithium battery can be effectively increased.

FIG. 4 is the result of reaction heat release analysis of experimental example 2. Referring to FIG. 4 and FIG. 2B, after respectively reacting at constant temperatures of 50° C., 60° C., 70° C., and 80° C. for 2 hours using a thermal analyzer, the heat released in experimental example 1 was respectively 16.63 J/g, 14.12 J/g, 12.97 J/g, and 10.59 J/g, and the heat released in comparative example 1 was respectively 14.82 J/g, 20.51 J/g, 29.47 J/g, and 46.15 J/g. It can be seen from FIG. 4 and FIG. 2B that, in comparative example 1, the reaction heat release is increased with reaction temperature, and in experimental example 1, the reaction heat release is reduced with increase in reaction temperature and the reaction time is shorter (3 minutes to 5 minutes). Therefore, in the invention, preparing the oligomer by reacting a maleimide, a barbituric acid, and a promoter in a solvent can effectively increase the conversion rate of the addition reaction of the maleimide and the barbituric acid, and the reaction can be completed at a lower temperature. Moreover, it can be known from the experimental results that, the heat released in experimental example 2 is lower, indicating the resulting oligomer has lower molecular weight. Therefore, in comparison to the case without the N—(CH₂CH₃)₃ promoter, the N—(CH₂CH₃)₃ promoter can be used in a lithium battery design with a low molecular weight requirement.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An oligomer obtained by reacting a maleimide, a barbituric acid, and a promoter in a solvent, wherein the promoter has a structure represented by formula 1:
X—(R)₃ formula 1,
wherein X is N or P; R is a substituted or unsubstituted C1-C10 alkyl group or a substituted or unsubstituted C6-C10 aryl group.

2. The oligomer of claim 1, wherein X is P and R is a phenyl group.

3. The oligomer of claim 1, wherein X is N and R is an ethyl group.

4. The oligomer of claim 1, wherein a molar ratio of the maleimide and the barbituric acid is between 1:1 and 4:1.

5. The oligomer of claim 1, wherein based on a total weight of the maleimide, the barbituric acid, and the promoter, an amount of the promoter is between 5 wt % and 20 wt %.

6. The oligomer of claim 1, wherein based on a total weight of the maleimide, the barbituric acid, and the solvent, a total amount of the maleimide and the barbituric acid is between 5 wt % and 20 wt %.

7. The oligomer of claim 1, wherein the maleimide comprises monomaleimide or bismaleimide, the monomaleimide is N-phenylmaleimide, N-(o-methylphenyl)-maleimide, N-(m-methylphenyl)-maleimide, N-(p-methylphenyl)-maleimide, N-cyclohexylmaleimide, maleimidophenol, maleimidobenzocyclobutene, phosphorus-containing maleimide, phosphonate-containing maleimide, siloxane-containing maleimide, N-(4-tetrahydropyranyl-oxyphenyl)maleimide, or 2,6-xylylmaleimide, and the bismaleimide has a structure represented by formula 2: 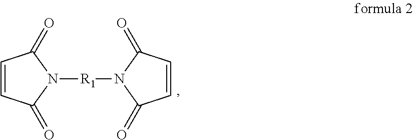
wherein R₁ is —(CH₂)₂—, —(CH₂)₆—, —(CH₂)₈—, —(CH₂)₁₂—,

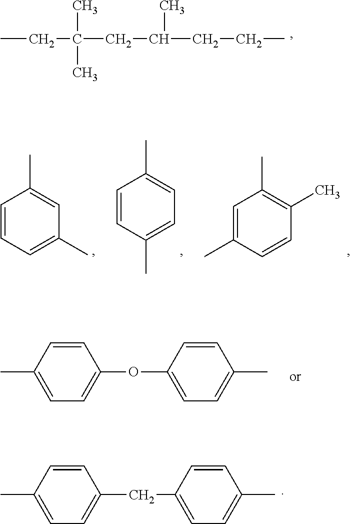

8. The oligomer of claim 1, wherein the barbituric acid has a structure represented by formula 3: 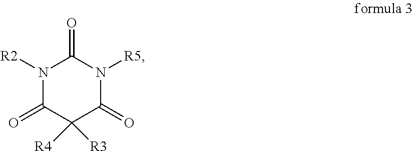
wherein R2, R3, R4, and R5 are each independently —H, —CH₃, —C₂H₅, —C₆H₅, —CH(CH₃)₂, —CH₂CH(CH₃)₂, —CH₂CH₂CH(CH₃)₂, or —CH(CH₃)—(CH₂)₂—CH₃.

9. A lithium battery, comprising:
an anode;
a cathode disposed separately from the anode, wherein the cathode comprises the oligomer of claim 1;
a separator disposed between the anode and the cathode, wherein the separator, the anode, and the cathode define a housing region;
an electrolyte solution disposed in the housing region; and
a package structure covering the anode, the cathode, and the electrolyte solution.

10. The lithium battery of claim 9, wherein the electrolyte solution comprises an organic solvent, a lithium salt, and an additive, wherein the additive comprises monomaleimide, polymaleimide, bismaleimide, polybismaleimide, a copolymer of bismaleimide and monomaleimide, vinylene carbonate, or a mixture thereof.
